(19) United States
(12) Patent Application Publication
(10) Pub. No.: US 2025/0356172 A1
(43) Pub. Date: Nov. 20, 2025

(54) AI Augmented Data Analysis

(71) Applicant: NATIONAL INSTRUMENTS CORPORATION, Austin, TX (US)

(72) Inventor: Alejandro Barreto, Austin, TX (US)

(21) Appl. No.: 19/210,652

(22) Filed: May 16, 2025

Related U.S. Application Data
(60) Provisional application No. 63/649,771, filed on May 20, 2024.

(51) Int. Cl. G06N 3/0475; G06F 40/169; G06F 40/40; G06N 3/006; G06N 3/08; G06T 11/20

(52) U.S. Cl. CPC G06N 3/0475; G06F 40/169; G06F 40/40; G06N 3/006; G06N 3/08; G06T 11/206

(57) ABSTRACT

Apparatuses, systems, and methods for artificial intelligence (AI) augmented data analysis can include providing a large language model (LLM), access to a data set. For example, an end user can interact with a user interface on a user device to provide instructions to the LLM to access the data set. In addition, the LLM can be interacted with via the user interface using natural language instructions and LLM output, based on the LLM analysis of the data set, can also be interacted with via the user interface. The LLM output can include one or more visualizations of the data set.

### PRIORITY CLAIM

This application claims benefit of priority to provisional application No. 63/649,771 entitled “AI Augmented Data Analysis”, filed on May 20, 2024, whose disclosure is hereby incorporated by reference in its entirety as though fully and completely set forth herein.

### TECHNICAL FIELD

The invention relates to data analysis, and more particularly to apparatuses, systems, and methods for generative Artificial Intelligence (AI) assisted data analysis, e.g., using a generative AI based system to analyze data generated via testing of a device under test (DUT).

### DESCRIPTION OF THE RELATED ART

Currently, there are a variety of tools to support a test engineer in test process development when given a specification of a DUT. For example, there are tools to aid a test engineer in the front-end of life cycle of a test process, e.g., such as tools to match tests to instruments. Further, there are tools to aid a test engineer in the back end of the life cycle of the test process, e.g., such as tools that provide measurement abstraction. In addition, there are various tools that provide high-level test support as well as tools that can generate test sequences based on detailed inputs from the test engineer.

However, a test engineer may need to work/interact with many, disparate software systems to leverage these various tools to develop the test process for the DUT. For example, in various aspects of development of the test process, a test engineer may have the role of a design engineer (e.g., during design of the DUT and/or development of tests that validate the design of the DUT as well as during design of tests than can be reused across the test life cycle of the DUT), test architect (e.g., during design of test systems and identification of reusable components for tests), validation engineer (e.g., during characterization and validation of DUTs), and/or production test engineer (e.g., during development of tests that monitor production processes as well as yield of production DUTs). Each role/tool may require its own expertise and resource, leading to high overhead costs in time, training, and expertise develop. These high overhead costs may then extend time to market for particular products. Therefore, improvements are desirable.

### SUMMARY

Embodiments described herein relate to computing systems, memory media, and methods for generative Artificial Intelligence (AI) assisted data analysis, e.g., using a generative AI based system to analyze data generated via testing of a device under test (DUT).

For example, methods described herein can analyze data generated via testing of a device under test (DUT), e.g., via leveraging a large language model (LLM) to generate analysis of measurement data provided to the LLM. For example, an end user can provide measurement data (e.g., a data set) to an LLM and then begin analysis via a “chat” style interaction with the LLM. In other words, the end user can have a natural language conversation with the LLM via a user interface styled as a chat box. The LLM can be trained on a set of tools associated with data analysis and a “conversation” between the end user and the LLM can lead to production of plots, figures, tables, and other outputs (e.g., visuals) based on the provided measurement data.

In some embodiments, a method for AI augmented data analysis can include providing a large language model (LLM), access to a data set. For example, an end user can interact with a user interface on a user device to provide instructions to the LLM to access the data set. In addition, the LLM can be interacted with via the user interface using natural language instructions and LLM output, based on the LLM analysis of the data set, can also be interacted with via the user interface. The LLM output can include one or more visualizations of the data set.

In some embodiments, a method for AI augmented data analysis can include an LLM receiving access to a data set. For example, an end user can interact with a user interface on a user device to provide instructions to the LLM to access the data set. The LMM can receive natural language commands associated with analysis of the data set and analyze the data set based, at least in part, on the natural language commands. The analysis can include determining suggestions for additional analysis as well as performing analysis tasks not included in the natural language commands.

Note that the techniques described herein can be implemented in and/or used with a number of different types of devices, including but not limited to cellular phones, tablet computers, wearable computing devices, portable computing devices, portable media players, and any of various other computing devices.

This Summary is intended to provide a brief overview of some of the subject matter described in this document. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the disclosed embodiments can be obtained when the following detailed description of the preferred embodiments is considered in conjunction with the following drawings.

FIG. 1 illustrates an example of a computer system, according to some embodiments.

FIG. 2 illustrates an example block diagram of a server 104, according to some embodiments.

FIG. 3 illustrates an example of a system supporting a test generation system, according to some embodiments.

FIGS. 4 and 5 illustrate block diagrams of examples of methods for augmented data analysis of a DUT, according to some embodiments.

While the features described herein can be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that can appear throughout the present disclosure are provided below:
AI: Artificial Intelligence
DUT: Device Under Test
UUT: Unit Under Test
VI: Virtual Instrument
GUI: Graphical User Interface
LLM: Large Language Model
JSON: JavaScript Object Notation

### Terms

The following is a glossary of terms used in this disclosure:

Device Under Test (DUT) or Unit Under Test (UUT)—A physical device or component that is being tested.

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium can include other types of non-transitory memory as well or combinations thereof. In addition, the memory medium can be located in a first computer system in which the programs are executed, or can be located in a second different computer system which connects to the first computer system over a network, such as the Internet. In the latter instance, the second computer system can provide program instructions to the first computer for execution. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks can range from fine grained (combinatorial logic or look up tables) to coarse grained (arithmetic logic units or processor cores). A programmable hardware element can also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Processing Element (or Processor)—refers to various elements or combinations of elements that are capable of performing a function in a device, such as a user equipment or a cellular network device. Processing elements can include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Program—the term “program” is intended to have the full breadth of its ordinary meaning. The term “program” includes 1) a software program which can be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that can be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program can comprise two or more software programs that interoperate in some manner.

Hardware Configuration Program—a program, e.g., a netlist or bit file, that can be used to program or configure a programmable hardware element.

Graphical Program—A program comprising a plurality of interconnected nodes or icons, where the plurality of interconnected nodes or icons visually indicate functionality of the program. Can also be referred to as a Virtual Instrument (VI).

Data Flow Graphical Program (or Data Flow Diagram)—A graphical program or diagram comprising a plurality of interconnected nodes, wherein the connections between the nodes indicate that data produced by one node is used by another node. Can also be referred to as a Virtual Instrument (VI).

Graphical User Interface—this term is intended to have the full breadth of its ordinary meaning. The term “graphical user interface” is often abbreviated to “GUI”. A GUI can comprise only one or more input GUI elements, only one or more output GUI elements, or both input and output GUI elements. Can also be referred to as a Virtual Instrument (VI).

The following provides examples of various aspects of GUIs. The following examples and discussion are not intended to limit the ordinary meaning of GUI, but rather provide examples of what the term “graphical user interface” encompasses:

A GUI can comprise a single window, panel, or dialog box having one or more GUI Elements, or can comprise a plurality of individual GUI Elements (or individual windows each having one or more GUI Elements), wherein the individual GUI Elements or windows can optionally be tiled together.

Graphical User Interface Element—an element of a graphical user interface, such as for providing input or displaying output. Exemplary graphical user interface elements include input controls and output indicators.

Input Control—a graphical user interface element for providing user input to a program. Exemplary input controls include buttons, check boxes, input text boxes, knobs, sliders, etc.

Output Indicator—a graphical user interface element for displaying output from a program. Exemplary output indicators include charts, graphs, gauges, output text boxes, numeric displays, etc. An output indicator is sometimes referred to as an “output control”.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure can be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form can be automatically filled out by the computer system where the computer system (e.g., software executing on the computer system) analyzes the fields of the form and fills in the form without any user input specifying the answers to the fields. As indicated above, the user can invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately can refer to a value that is within 1 to 10 percent of the exact (or desired) value. It should be noted, however, that the actual threshold value (or tolerance) can be application dependent. For example, in some embodiments, “approximately” can mean within 0.1% of some specified or desired value, while in various other embodiments, the threshold can be, for example, 2%, 3%, 5%, and so forth, as desired or as required by the particular application.

Concurrent—refers to parallel execution or performance, where tasks, processes, or programs are performed in an at least partially overlapping manner. For example, concurrency can be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

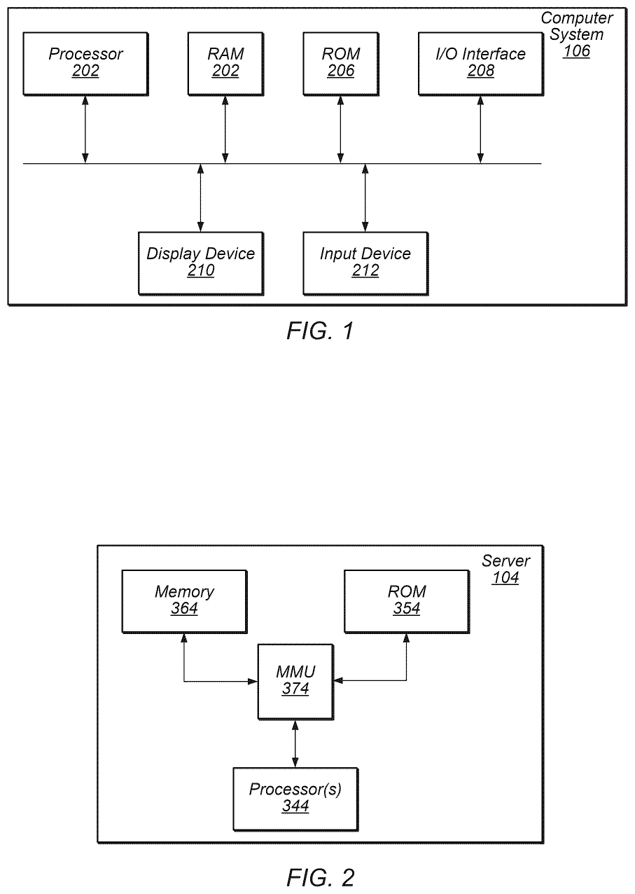

### FIG. 1: Computer System

FIG. 1 illustrates a computer system 106 that can include a processor 202, random access memory (RAM) 204, nonvolatile memory 206, a display device 210, an input device 212 and an I/O interface 208 for coupling to sensors. For example, the computer system 106 can include hardware and software components for implementing or supporting implementation of features described herein. The processor 202 can be configured to implement or support implementation of part or all of the methods described herein, e.g., by executing program instructions stored on a memory medium (e.g., a non-transitory computer-readable memory medium). Alternatively, the processor 202 can be configured as a programmable hardware element, such as an FPGA (Field Programmable Gate Array), or as an ASIC (Application Specific Integrated Circuit), or a combination thereof. Alternatively (or in addition) the processor 202, in conjunction with one or more of the other components 204, 206, 208, 210, and/or 212 can be configured to implement or support implementation of part or all of the features described herein.

In addition, as described herein, processor(s) 202 can be comprised of one or more processing elements. In other words, one or more processing elements can be included in processor(s) 202. Thus, processor(s) 202 can include one or more integrated circuits (ICs) that are configured to perform the functions of processor(s) 202. In addition, each integrated circuit can include circuitry (e.g., first circuitry, second circuitry, etc.) configured to perform the functions of processor(s) 202.

As shown, the computer system 106 can include a processor that is coupled to a random access memory (RAM) and a nonvolatile memory. The computer system 106 can also include user interface elements for receiving user input and a display device for presenting output. For example, the user interface elements can include any of various elements, such as a display (which can be a touchscreen display), a keyboard (which can be a discrete keyboard or can be implemented as part of a touchscreen display), a mouse, a microphone and/or speakers, one or more cameras, one or more buttons, and/or any of various other elements capable of providing information to a user and/or receiving or interpreting user input. The computer system 106 can also include an Input/Output (I/O) interface that can be communicatively coupled (e.g., locally via a system bus, or remotely via a network and/or serial interface) to various hardware elements (e.g., such as FPGAS, data acquisition boards, controllers, and the like).

### FIG. 2: Server

FIG. 2 illustrates an example block diagram of a server 104, according to some embodiments. It is noted that the server of FIG. 2 is merely one example of a possible server. As shown, the server 104 can include processor(s) 344 which can execute program instructions for the server 104. The processor(s) 344 can also be coupled to memory management unit (MMU) 374, which can be configured to receive addresses from the processor(s) 344 and translate those addresses to locations in memory (e.g., memory 364 and read only memory (ROM) 354) or to other circuits or devices.

The server 104 can be configured to provide a plurality of devices, such as computer system 106, access to a generative AI, e.g., as further described herein.

In some embodiments, the server 104 can access via a radio access network, such as a 5G New Radio (5G NR) radio access network. In some embodiments, the server 104 can be accessed via a local area network (LAN), e.g., via an ethernet and/or Wi-Fi connection.

As described further subsequently herein, the server 104 can include hardware and software components for implementing or supporting implementation of features described herein. The processor 344 of the server 104 can be configured to implement or support implementation of part or all of the methods described herein, e.g., by executing program instructions stored on a memory medium (e.g., a non-transitory computer-readable memory medium). Alternatively, the processor 344 can be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 can be configured to implement or support implementation of part or all of the features described herein.

In addition, as described herein, processor(s) 344 can be comprised of one or more processing elements. In other words, one or more processing elements can be included in processor(s) 344. Thus, processor(s) 344 can include one or more integrated circuits (ICs) that are configured to perform the functions of processor(s) 344. In addition, each integrated circuit can include circuitry (e.g., first circuitry, second circuitry, etc.) configured to perform the functions of processor(s) 344.

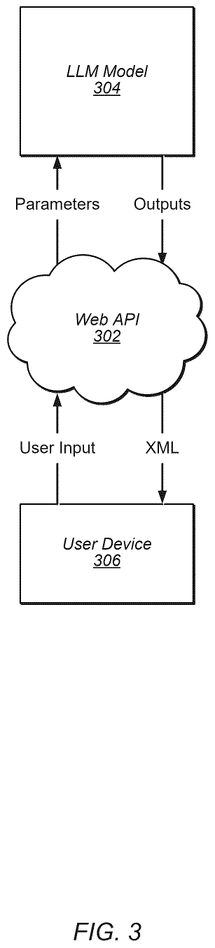

### FIG. 3: Test Generation System

FIG. 3 illustrates an example of a system supporting a test generation system, according to some embodiments. As shown, the system can include a user device 306, e.g., which can be a computer system 106 that provides an interface with a LLM model 304 (e.g., which can be hosted on a server, such as server 104) via a web Application Programming Interface (API) 302. In at least some instances, the LLM model 304 can be one or more models 304 (e.g., one or more artificial intelligence models). The interface can allow the LLM model 304 to interact with (e.g., communicate with) local hardware either on the user device 306 and/or in communication with the user device 306. In addition, the interface can allow the LLM model 304 to interact with local software resources (e.g., such as programming platforms (e.g., LabVIEW™, Python, MeasurementLink, C++, MATLAB™, and so forth). Thus, as shown, a user can interact with the LLM model 304 via web API 302 using the user device 306. The user device 306 can execute one or more software resources as well as host hardware (e.g., such as data acquisition boards, control boards, vision boards, and the like) and/or communicate with remote hardware (e.g., such as data acquisition boards, control boards, vision boards, and the like). The user device 306 can provide user inputs, including information regarding available hardware and/or software resources to the web API 302. The web API 302 can convert the user inputs to LLM model parameters and/or the web API 302 can generate LLM model parameters based on the user inputs. The LLM model parameters can be used by the LLM model 304 to generate and/or produce model outputs that are returned to the web API 302. The web API 302 can then convert the model outputs to Extensible Markup Language (XML) and/or generate XML based on the model outputs. For example, the model outputs can include programming code (e.g., such as graphical programming code) that can be converted (e.g., serialized) to Large Language Model (LLM) optimized XML, JavaScript Object Notation (JSON), and/or a Domain Specific Language (DSL). The XML can then be delivered to the user device 306 as natural language output to an end user. In this manner, the LLM model 304 can interact with the end user to generate and/analyze data generated via testing of a device under test (DUT). Note that the LLM model 304 can be trained to query end users using a plurality of prompts based on user input. Further, the LLM model 304 can be trained to generate graphical programs based on consuming graphical programs, e.g., the LLM model 304 can be trained using thousands of graphical programs. Note further, that aspects of the LLM model 304 can include a user interface executing on the user device 306 as well as background software to discover and maintain hardware information as well as to discover and maintain connections with local applications, the web API 302 to allow the user device 306 to interact with the LLM model 304, and the LLM model 304 that can be executing on a server remote from the user (e.g., the LLM model 304 can be cloud based).

### AI Augmented Data Analysis

Currently, a test engineer may need to work/interact with many, disparate software systems to leverage various tools to develop a test process for a device under test (DUT). Thus, the current test engineer needs to not only understand the DUT to design the test process, but additionally be versed in a vast array of tools. In various aspects of development of the test process, the test engineer may have the role of a design engineer (e.g., during design of the DUT and/or development of tests that validate the design of the DUT as well as during design of tests than can be reused across the test life cycle of the DUT), test architect (e.g., during design of test systems and identification of reusable components for tests), validation engineer (e.g., during characterization and validation of DUTs), and/or production test engineer (e.g., during development of tests that monitor production processes as well as yield of production DUTs). Each of these roles/tools require independent expertise and resources, leading to high overhead costs in time, training, and expertise develop. These high overhead costs can then extend time to market for particular products.

In particular, during all phases of test development, a test engineer is required to collect, review, and analyze data to draw conclusions associated with both the test design and validation of a DUT. Thus, a test engineer can leverage several tools for such measurement data analysis, including spreadsheets, programing code, and other specialized tools for measurement data analysis. Each tool may require specific training, knowledge, and experience to be efficiently leveraged further adding to higher overhead costs than can extend time to market for particular products. Therefore, improvements are desirable.

Embodiments described herein provide systems, methods, and mechanisms to analyze data generated via testing of a device under test (DUT), e.g., via leveraging a large language model (LLM) to generate analysis of measurement data provided to the LLM. For example, an end user can provide measurement data (e.g., a data set) to an LLM and then begin analysis via a “chat” style interaction with the LLM. In other words, the end user can have a natural language conversation with the LLM via a user interface styled as a chat box. The LLM can be trained on a set of tools such as code writing, analysis toolkit calls, and plot creation. Thus, a “conversation” between the end user and the LLM can lead to production of plots, figures, tables, and other outputs (e.g., visuals) based on the provided measurement data. The end user can “guide” the LLM through the analysis of the measurement data and/or the LLM can be trained to perform analysis of the provided measurement data without guidance from the end user. In addition, the LLM can consume produced analysis, formulate conclusions, and suggest additional analysis, improvements to a test system used to generate the provided measurement data, improvements to the DUT, and/or improvements to the analysis in general.

In some instances, the LLM can consume specification documents associated with the DUT, test programs used in the test system testing the DUT, test engineering instructions, project files, and so forth. In other words, the LLM can consume various forms of documentation associated with the DUT, including, but not limited to, programming code (both high level programming code and low level programming code), word processing documents, Portable Document Format (PDF) documents, spreadsheets, presentation documents, three-dimensional (3D) models, two-dimensional (2D) models, images, videos, and/or other multimedia recordings, among other file types and/or formats. Further, the LLM can be trained to create programming code (e.g., for data analysis, analysis presentation, test system design, and so forth), access proprietary measurement toolkits, download analysis libraries at runtime, and run programming code (either end user generated or LLM generated).

Note that in at least some instances, the LLM may not consume the provided measurement data. Instead, the LLM works with the provided measurement data to generate code to analyze the data and derive insights in the form of text output and/or visuals.

In some instances, the LLM can consume data generated to produce the text output and/or visuals, images of the text output and/or visuals, as wells as results that the LLM determines to be useful. The LLM can then generate code to provide further analysis on the consumed data and output further analysis and summaries of the consumed data.

In some instances, an end user can interact with the text output and/or visuals (e.g., results) produced by the LLM to annotate the results. The LLM can then consume the annotations and provide further analysis based on the annotations.

In some instances, a user interface used to interact with the LLM and provided results can be scrollable, allowing an end user to scroll between current provided results and prior provided results.

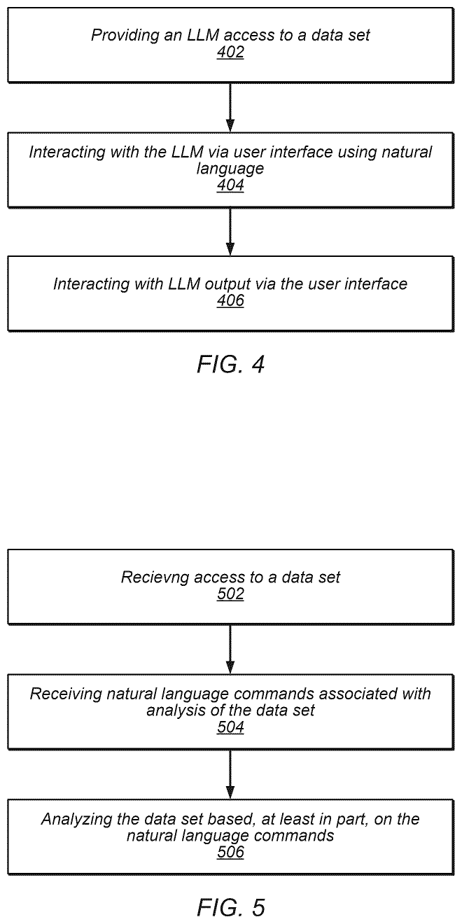

For example, FIGS. 4 and 5 illustrate block diagrams of examples of methods for augmented data analysis of a DUT, according to some embodiments. The methods shown in FIGS. 4 and 5 can be used in conjunction with any of the systems, methods, or devices shown in the Figures, among other devices. In various embodiments, some of the elements shown can be performed concurrently, in a different order than shown, or can be omitted. Additional elements can also be performed as desired. Turning to FIG. 4, as shown, this method can operate as follows.

At 402, a large language model (LLM), such as LLM 304 can be provided access to a data set. For example, an end user can interact with a user interface on a user device, such as user device 306, to provide instructions to the LLM to access the data set. The instructions can be provided directly to the LLM from the user device or can be provided to the LLM via an Application Program Interface (API), such as API 302. In some instances, the LLM can be located on a server. The server can be a cloud-based server, at least in some instances. In some instances, the user interface can include a chat box for interacting with and/or providing instructions and/or commands to the LLM.

At 404, the LLM can be interacted with via the user interface using natural language instructions.

At 406, LLM output, based on the LLM analysis of the data set, can be interacted with via the user interface. The LLM output can include one or more visualizations of the data set. For example, the one or more visualizations can include any, any combination of, and/or all of (e.g., at least one of and/or one or more of) a data plot illustrating analysis of the data set, a figure illustrating analysis of the data set, and/or a table illustrating analysis of the data set. In some instances, interactions with the LLM output via the user interface can include annotating the LLM output via the user interface. In such instances, additional LLM output based on the annotating can be received via the user interface.

In some instances, prior to providing the data set to the LLM, the LLM can be trained on one or more data analysis tools. The one or more data analysis tools can include any, any combination of, and/or all of (e.g., at least one of and/or one or more of) code writing (and/or code generation), analysis toolkit calls, plot creation, code execution, and/or analysis library access.

In some instances, specification documents associated with a device under test (DUT) can be provided to the LLM. In such instances, the data set can be produced from testing of the DUT. The documents associated with the DUT can include any, any combination of, and/or all of (e.g., at least one of and/or one or more of) programming code, word processing documents, Portable Document Format (PDF) documents, spreadsheets, presentation documents, three-dimensional (3D) models, two-dimensional (2D) models, images, and/or videos. Further, in such instances, the LLM output can include a recommendation for DUT improvements.

In some instances, information associated with testing performed on a DUT to produce the data set can be provided to the LLM. The information associated with the testing can include any, any combination of, and/or all of (e.g., at least one of and/or one or more of) testing hardware documentation, testing procedure documentation, and/or testing procedure code. Further, in such instances, the LLM output can include a recommendation for test improvement.

Turning to FIG. 5, as shown, this method can operate as follows.

At 502, a large language model (LLM), such as LLM 304, can receive access to a data set. For example, an end user can interact with a user interface on a user device, such as user device 306, to provide instructions to the LLM to access the data set. The instructions can be provided directly to the LLM from the user device or can be provided to the LLM via an Application Program Interface (API), such as API 302. In some instances, the LLM can be located on a server. The server can be a cloud-based server, at least in some instances. In some instances, the user interface can include a chat box for interacting with and/or providing instructions and/or commands to the LLM.

At 504, natural language commands associated with analysis of the data set can be received at the LLM.

At 506, the LLM can analyze the data set based, at least in part, on the natural language commands. In some instances, the analysis can include determining suggestions for additional analysis. In some instances, the analysis can include the LLM performing analysis tasks not included in the natural language commands.

In some instances, the LLM can provide LLM output via the user interface in communication with the LLM. The LLM output can be based on the LLM analysis of the data set. The LLM output can include one or more visualizations of the data set. For example, For example, the one or more visualizations can include any, any combination of, and/or all of (e.g., at least one of and/or one or more of) a data plot illustrating analysis of the data set, a figure illustrating analysis of the data set, and/or a table illustrating analysis of the data set. In some instances, the LLM can receive annotations of the LLM output, e.g., annotations performed via the user interface. In such instances, the LLM can consume the annotations of the LLM output and perform additional analysis based, at least in part, on the annotations. The LLM can then provide additional LLM output via the user interface. The additional LLM output can be based, at least in part, on the additional analysis.

In some instances, prior to performing the analysis, the LLM can consume one or more data analysis tools. The one or more data analysis tools can include any, any combination of, and/or all of (e.g., at least one of and/or one or more of) code writing (and/or code generation), analysis toolkit calls, plot creation, code execution, and/or analysis library access.

In some instances, prior to performing the analysis, the LLM can consume specification documents associated with a device under test (DUT). In such instances, the data set can be produced from testing of the DUT. The documents associated with the DUT can include any, any combination of, and/or all of (e.g., at least one of and/or one or more of) programming code, word processing documents, Portable Document Format (PDF) documents, spreadsheets, presentation documents, three-dimensional (3D) models, two-dimensional (2D) models, images, and/or videos. Further, in such instances, the LLM output can include a recommendation for DUT improvements, e.g., the analysis performed by the LLM can include determining recommendations for DUT improvements.

In some instances, prior to performing the analysis, the LLM can consume information associated with testing performed on the DUT to produce the data set. The information associated with the testing can include any, any combination of, and/or all of (e.g., at least one of and/or one or more of) testing hardware documentation, testing procedure documentation, and/or testing procedure code. Further, in such instances, the LLM output can include a recommendation for test improvement, e.g., the analysis performed by the LLM can include determining recommendations for test improvement.

Embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a computer system 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for artificial intelligence (AI) assisted data analysis, comprising:
providing a large language model (LLM) access to a data set;
interacting with the LLM via a user interface using natural language; and
interacting with LLM output via the user interface, wherein the output is based on LLM analysis of the data set.

2. The method of claim 1,
wherein the user interface includes a chat box for interacting with the LLM.

3. The method of claim 1,
wherein the LLM output includes one or more visualizations of the data set.

4. The method of claim 3,
wherein the one or more visualizations include one or more of a data plot illustrating analysis of the data set, a figure illustrating analysis of the data set, or a table illustrating analysis of the data set.

5. The method of claim 1,
wherein interacting with the LLM output via the user interface comprises:
annotating the LLM output via the user interface.

6. The method of claim 5, further comprising:
receiving additional LLM output based on the annotating.

7. The method of claim 1, further comprising:
training, prior to providing the LLM the data set, the LLM on one or more data analysis tools.

8. The method of claim 7,
wherein the one or more data analysis tools include one or more of:
code writing;
analysis toolkit calls;
plot creation;
code execution; or
analysis library access.

9. A non-transitory computer-readable memory medium storing program instructions which, when executed by a processor, are configured to cause a computing device to perform operations comprising:
providing a large language model (LLM) access to a data set;
interacting with the LLM via a user interface using natural language; and
interacting with LLM output via the user interface, wherein the output is based on LLM analysis of the data set.

10. The non-transitory computer readable memory medium of claim 9,
wherein the program instructions are further executable by the processor to cause the computing device to perform operations comprising:
providing, to the LLM, specification documents associated with a device under test (DUT), wherein the data set is produced from testing of the DUT.

11. The non-transitory computer readable memory medium of claim 10,
wherein the documents associated with the DUT include one or more of:
programming code;
word processing documents;
Portable Document Format (PDF) documents;
spreadsheets;
presentation documents;
three-dimensional (3D) models;
two-dimensional (2D) models;
images; or
videos.

12. The non-transitory computer readable memory medium of claim 10,
wherein the LLM output includes a recommendation for DUT improvements.

13. The non-transitory computer readable memory medium of claim 10,
wherein the documents associated with the DUT include one or more of:
providing, to the LLM, information associated with testing performed on a device under test (DUT) to produce the data set.

14. The non-transitory computer readable memory medium of claim 13,
wherein the information associated with the testing includes one or more of:
testing hardware documentation;
testing procedure documentation; or
testing procedure code.

15. The non-transitory computer readable memory medium of claim 13,
wherein the LLM output includes a recommendation for test improvement.

16. An apparatus, comprising:
a memory; and
at least one processor in communication with the memory and configured to perform operations comprising:
providing a large language model (LLM) access to a data set;
interacting with the LLM via a user interface using natural language; and
interacting with LLM output via the user interface, wherein the output is based on LLM analysis of the data set.

17. The apparatus of claim 16,
wherein the LLM output includes suggestions for additional analysis.

18. The apparatus of claim 16,
wherein the user interface communicates with the LLM via an Application Program Interface (API);
wherein the LLM is located on a server; and
wherein the server is a cloud-based server.

19. The apparatus of claim 16,
wherein the user interface includes a chat box for interacting with the LLM.

20. The apparatus of claim 16,
wherein the LLM output includes one or more visualizations of the data set.
